(19) United States
(12) Patent Application Publication
(10) Pub. No.: US 2025/0039613 A1
(43) Pub. Date: Jan. 30, 2025

(54) FLEXIBLE CONDUCTIVE HEARING AIDS

(71) Applicant: Board of Trustees of Northern Illinois University, DeKalb, IL (US)

(72) Inventor: S. Mohammad J. Moghimi, DeKalb, IL (US)

(73) Assignee: Board of Trustees of Northern Illinois UNiversity, DeKalb, IL (US)

(21) Appl. No.: 18/716,904

(22) PCT Filed: Dec. 8, 2022
(86) PCT No.: PCT/US2022/052241

§ 371 Date: Jun. 5, 2024

Related U.S. Application Data
(60) Provisional application No. 63/288,457, filed on Dec. 10, 2021.

(51) Int. Cl. H04R 25/00

(52) U.S. Cl. CPC H04R 25/48; H04R 25/606

(57) ABSTRACT

A flexible conductive hearing aid, comprises: (i) a flexible substrate, (ii) components, on or in the flexible substrate, including (a) a microphone, configured to produce an electrical signal from sound, (b) electronic circuits, connected to the microphone, configured to amplifying the electrical signal, (c) an actuator, connected to the electronic circuits, configures to produce vibrations in the flexible substrate from the amplified electrical signal, and (d) a power source, connected to the microphone and the electrical circuits. Furthermore, the flexible conductive hearing aid comprise (iii) optionally, a flexible top layer, on the components, and (iv) optionally, a flexible bottom layer, wherein the flexible substrate is on the flexible bottom layer.

### FEDERALLY SPONSORED RESEARCH OR DEVELOPMENT

This invention was made with Government support under of grant no. 1R21DC018894-01A1 awarded by the National Institutes of Health—National Institute on Deafness and Other Communication Disorders (NIH-NIDCD). The Government has certain rights in the invention

### BACKGROUND

Hearing loss that results from the mechanical obstruction of the anatomical pathways of the ear is termed conductive hearing loss (CHL) [24], [25]. The many conditions that cause CHL prevent sounds from being efficiently transmitted down the external ear canal to the cochlea of the inner ear, causing temporary or permanent hearing loss. CHL is the most common type of hearing impairment among infants and young children. Untreated, enduring, unaided CHL in the early stage of life delays language and speech development [26], which reduces the quality of life and leads to poor school performance, alienation in school, low academic achievement, and ultimately low socio-economic level [26]. Therefore, for long-lasting hearing health, and for language development, it is essential to detect CHL in newborns and infants and intervene as early as possible.

Pediatric CHL is often caused by reversible common conditions, such as otitis media and tympanic membrane perforations; 80% of children experience some episode of otitis media before school age [27]. Otitis media is generally treated with antibiotics or tympanostomy tube insertion. Tympanic membrane perforation has a lower incidence rate and is repaired by surgery. The procedure requires general anesthesia and lasts approximately 1-3 hours. Pediatric CHL is also caused by permanent anatomical conditions, such as aural atresia, canal stenosis and ossicular malformation. These conditions are not as common as transient CHL. For instance, congenital aural atresia has a 1:10,000 to 1:20,000 incidence rate [28]-[30], and ossicular malformation has an incident rate of 0.6% in children under 5 [31]. These conditions result in a 40-60 dB permanent hearing loss and are much more difficult to address. Hearing aids can sometimes be placed if there is an existent ear canal. Alternatively, a bone conduction aid can be implanted. Otherwise, surgical options for these pediatric CHL include canalplasty/ossicular chain reconstruction.

Treatment options in canal atresia, stenosis and ossicular malformation have limitations and present challenges for pediatric patients. Lack of the ear canal or opening in atresia and narrowed canal in stenosis do not physically accommodate hearing aids in the external canal; therefore, in-the-canal aids are not practical for atresia and stenosis. The abnormal or unformed boney ear canal is usually accompanied by malformation of the three tiny ear bones: the malleus, incus and stapes. Ossicular chain reconstruction is usually needed at the same time as the canalplasty and attempts to repair or replace the abnormal connections among the three small ear bones. Canaloplasty itself—to surgically create or widen the canal in the ear—has a decades-long history of very disappointing results. These canals typically re-stenose, and the postoperative CHL is little improved. Several anatomical grading systems (based on CT) have been developed, including the Jahrsdoerfer grading scale, to try to select candidates for ear canal surgery who have middle and inner ear anatomy closest to normal morphology [32]. These have the best chance of hearing improvement with canalplasty. However, even with careful selection, re-creating an ear canal and reconstruction of the small ear bones do not usually succeed. Stapedectomy, an operation for stapes fixation in adults [33], tends to be quite successful. However, the underlying condition is not common in children, and therefore stapedectomy has no role for most pediatric patients. Auditory osseointegrated implants (AOI's) are implanted into the superficial bony cortex of the skull to provide an alternative pathway for acoustic transmission and to bypass the child's permanent CHL [34], [35]. The surgery for AOI placement requires approximately one hour of general anesthesia and carries the risk of exposing or even tearing the meninges, which are the fibrous casing of the brain. In addition, the AOI requires a small metal pedestal that protrudes through the scalp, and typically these become overgrown by scalp months to years after the placement and must be repeatedly revised surgically. Because of the limitations of the skull, surgeons typically wait until children are 5 years old to implant AOIs [36]-[38]. An additional issue with AOIs is that many of the children and adolescents refuse to wear them because the external processor protrudes from their scalp and hair approximately 2-3 centimeters.

Few non-invasive conductive hearing aids exist to address CHL and are especially needed for the 5-year interval before the AOI or the canalplasty can be attempted. However, these alternatives have some disadvantages for pediatric patients. For instance, intraoral conduction aids are non-surgical devices to transfer sounds into the cochlea via teeth (for example, SOUNDBITE™ by Sonitus Medical) [39], but they are not practical for newborns and infants with undeveloped teeth. Bone conduction headbands (for example, Softbands) are wearable [40] and do not require surgical and invasive procedures, but these are cumbersome and uncomfortable for children and frequently fall off the child's scalp. MED-EL® company has developed a bone conduction hearing aid, called ADHEAR®, with a rigid piece of plastic, accommodating the sound processor. The rigid part has one adhesive surface that is applied to the skin and must be replaced regularly. The daily removal is cumbersome and peeling off the device is abrasive to the skin. Also, the rigidity of the device can be uncomfortable for pediatric patients.

### SUMMARY

In a first aspect, the present invention is a flexible conductive hearing aid, including: (i) a flexible substrate, (ii) components, on or in the flexible substrate, including (a) a microphone, configured to produce an electrical signal from sound, (b) electronic circuits, connected to the microphone, configured to amplifying the electrical signal, (c) an actuator, connected to the electronic circuits, configures to produce vibrations in the flexible substrate from the amplified electrical signal, and (d) a power source, connected to the microphone and the electrical circuits. Furthermore, the flexible conductive hearing aid comprise (iii) optionally, a flexible top layer, on the components, and (iv) optionally, a flexible bottom layer, wherein the flexible substrate is on the flexible bottom layer.

In a second aspect, the present invention is a method of treating conductive hearing loss with a flexible conductive hearing aid having a flexible substrate and optional a flexible bottom layer, the method including attaching the flexible conductive hearing aid to skin on a patient's skull, producing an electrical signal from ambient sound, amplifying the electrical signal, to produce an amplified electrical signal, and producing vibrations in the flexible conductive hearing aid from the amplified electrical signal.

### Definitions

“Flexible” means that the material will undergo elastic deformation when manipulated by hand.

### BRIEF DESCRIPTION OF THE DRAWINGS

FIG. 1 is an illustration of a flexible conductive hearing aid showing details of the component layer.

FIG. 2 is an illustration of a side view of a flexible conductive hearing aid showing the layers of the device.

FIG. 3 is a flow chart showing a method carried out by the flexible conductive hearing aid.

FIG. 4 is a circuit diagram showing a circuit which may be used to convert a sound signal into an amplified and filtered signal to drive an actuator.

FIG. 5 is a schematic of an actuator for transmitting vibrations through the skin and through bone, to the cochlea of a person so that the vibrations will be perceived as sound.

FIG. 6 illustrates a flexible conductive hearing aid attached to the skin behind the ear of an infant.

FIG. 7 illustrates sounds in the environment converted to vibrations on the epidermis to transfer sounds to cochlea, by the flexible conductive hearing aid as shown in FIG. 6.

FIG. 8 is a graph of simulation results of induced stress in bone versus the thickness

FIG. 9 is a graph of simulation results of stress in bone versus diameter of PZT.

FIG. 10 is a graph showing displacement of vibration at various distance from the actuator on calvarium.

FIG. 11 shows the experimental setup to measure vibrations from a microepidermal actuator. The cross-sectional view of the actuator with PZT, brass and PDMS is shown. The actuators produce vibrations on an aluminum plate and 352B accelerometer.

FIG. 12 is a graph of measured acceleration of an electromagnetic bone conduction actuator and a 15 mm diameter microepidermal actuator on 100 μm-thick PDMS for a frequency band of 10 kHz.

FIG. 13 is a graph of acceleration of a 15 mm-diameter PZT actuator with a brass plate and without PDMS at different distance from the accelerometer.

FIG. 14 is a graph of acceleration of a 15 mm-diameter microepidermal actuator at different distance from the accelerometer. The peak shifted from 5 kHz at 3 cm to 8 kHz at 8 cm.

FIG. 15 and FIG. 16 show the experimental setup to measure the vibrations from actuators of unimorph circular piezoelectric actuators on flexible substrates placed on 1-mm thick aluminum plates as foundations.

FIG. 17 is a graph of transmissibility (T) of velocity from the center of PZT to the backside of the rigid aluminum plate measured with LDV.

FIG. 18 is a graph of a polynomial fit for displacement on the surface of devices at 5 kHz: the solid line is mode shape of PZT layer on PBP; the dashed line is mode shape of PDMS surface on PPBP.

FIG. 19 and FIG. 20 show transient and AC sweep simulation, displaying three stages: microphone input, first amplification, second amplification.

FIG. 21 illustrates the PCB schematic design and the PCB print of the device.

FIG. 22 is a graph of the voltage response of the assembly of Example 5, tested at specific decibels across a range of 10 kHz.

FIG. 23 shows a device having the batteries and the circuit on one side, with the actuator on the reverse side, demonstrating the flexibility of the device and attachment to a skull.

FIG. 24 shows the device being tested on a willing and healthy participant.

FIG. 25 is a schematic of the device with a wireless charging coil of Example 5.

FIG. 26 is the PCB design of the device with a wireless charging coil of Example 5.

FIG. 27 shows a block diagram of a charger circuit.

FIG. 28 shows a wireless charger integrated on a hearing aid device viewed with Eagle CAD.

### DETAILED DESCRIPTION

New strategies to non-invasively transfer sound into the inner ear and eliminate the need for surgical procedures and cumbersome aids for pediatric patients is needed. Such a device should include soft, ultra-thin, lightweight micro-epidermal actuators (MEAs) attached to the epidermis on the skull which generate enough acoustic vibrations to conduct sound to the cochlea and bypass CHL. Micro-transducers on elastomeric substrates, including flexible speakers and microphones, have been widely shown in the literature [57], [59], [60]. Flexible electronics with a small size and low elastic modulus have been experimentally shown to adhere to skin with natural forces [1], [2]. The mechanism of acoustic transmission into the inner ear via skin-bone has been shown in COCHLEAR® and MED-EL products. However, the device that is needed should significantly reduce the size and weight of the hearing aid and eliminate the need for straps and rigid transducers, minimizing the risks for newborns and infants.

The present invention provides a hearing aid to address CHL, referred to as a flexible conductive hearing aid. This device is non-invasive, stable and unnoticeable on the head. The device does not have any rigid components to exert pressure on the skin and is not abrasive to the skin, but is powerful enough to bypass CHL. Micro-epidermal actuators were design and fabricate to transfer vibrations from the surface of skin to skull and to the cochlea of a person. The actuators and electronics are implemented on a thin flexible substrate to stick behind the ear and bypass conductive hearing loss.

An important element of this innovation is to miniaturize the components needed for hearing aids and to implement them onto the ultrathin, soft and flexible substrate to achieve a pediatric friendly conductive hearing aid. The device is unnoticeable on the skin, reducing the stigma surrounding visible hearing aids. The device is built onto bio-compatible and soft substrates and is optionally wirelessly charged or powered and may not need to be replaced daily. With this device, the size of a novel hearing aid could be as small as 1.5 cm×2.5 cm×300 μm and the weight is less than 120 milligrams. Such a flexible device will stick to skin with an adhesion strength of 1-2 kPa. The device will record sounds in the environments with a small microphone and transmit the amplified signals to the inner ear in the form of vibrations. The sound may be produced, for example, with a piezoelectric, microelectromechanical actuator. The strength of the vibrations may be increased by using multiple actuators. Such a flexible conductive hearing aid is conformal, lightweight and on an ultrathin substrate that moves with facial and natural body motion and, thus stabilizes the hearing aid on the skin and reduces the rubbing noises against the skin.

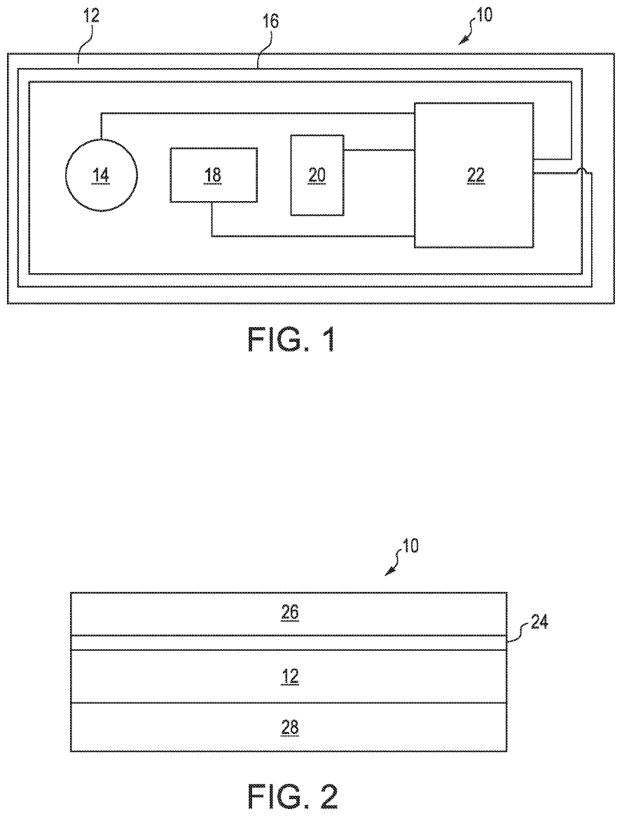

FIG. 1 is an illustration of a flexible conductive hearing aid, 10, showing details of the components which may be present as a component layer. The component layer is on a flexible insulating substrate, 12. The components include a microphone, 14, an actuator, 18, electronic circuits, 20, and a power source, 22. Also illustrated in an optional antenna, 16, which may also be referred to as a receiver coil. The thickness of the component layer will vary with the thickness of each component. Preferably, the component layer has a thickness of 1-50 μm, including a thickness of 2, 3, 4, 5, 6, 7, 8, 9, 10, 15, 20, 25, 30, 35, 40 and 45 μm.

FIG. 2 is an illustration of a side view of a flexible conductive hearing aid, 10, showing the layers of the device. In this aspect, all the components are present in a layer, however in a different aspect the components may be present in different layers or embedded within the substrate. As show, a component layer, 24, which includes the components shown in FIG. 1, is on a flexible insulating substrate, 12. These two layers are sandwiched between a flexible insulating top layer, 26, and an optional flexible insulating bottom layer, 28. Any flexible insulating polymer material may be used for the substrate, top layer and bottom layer. Preferably, the polymer material is biocompatible, such as a silicone elastomer (for example, polydimethylsiloxane (PDMS)), poly(butylene adipate-co-terephthalate) (PBAT)(such as ECOFLEX®), polylactic acid, polyimide, and blends and copolymers thereof. Hydrogels and other biocompatible gels may be used, so long as the component layer is sealed or otherwise protected from moisture. Examples include polyacrylamide, polyvinyl pyrrolidone (PVP), silicone hydrogels, polyurethanes (such as thermoplastic polyurethanes) and hydrogels used in contact lenses (for example tefilcon, hioxyfilcon A, lidofilcon, omafilcon A, hefilcon C, phemfilcon, methafilcon A and ocufilcon D) and mixtures thereof. Other examples include polymers and co-polymers of 2-hydroxyethylmethacrylate, glycerol methacrylate, methyl methacrylate, N-vinyl pyrrolidone, N-vinyl-2-pyrrolidone, 2-methacryloyloxyethyl phosphorylcholine, ethoxyethyl methacrylate and methacrylic acid. The hydrogel will also contain water, and may contain one or more salts such as sodium chloride, buffers, preservatives, plasticisers and polyethylene glycol. Examples of hydrogel thermoplastic polyurethanes (TPUs) include TECOPHILIC® thermoplastic polyurethanes. These TPUs offer an aliphatic, hydrophilic polyether-based resin which has been specially formulated to absorb equilibrium water contents from 20 to 1000% of the weight of dry resin. Examples of TPUs include TECOPHILIC® SP-80A-150 (“SP-80A-150”) and TECOPHILIC® Hydrogel TG-500 (TG-500″), manufactured by LUBRIZOL®. Silicones consist of an inorganic silicon-oxygen backbone chain with organic side groups attached to the silicon atoms. Silicones have in general the chemical formula [R₂SiO]ₙ, where R is an organic group such as an alkyl or phenyl group. Other polymers which may be used include medical-grade polymers approved for body contact. Examples of suitable plastics and polymers include acetal copolymer, acetal homopolymer, polyethylene terphthalate polyester, polytetrafluoroethylene, ethylene-chlorotrifluoro-ethylene, polybutylene terephthalate-polyester, polyvinylidene fluoride, polyphenylene oxide, polyetheretherketone, polycarbonate, polyethylenes, polypropylene homopolymer, polyphenylsulfone, polysulfone, polyethersulfone, and polyarylethersulfone. If the polymer used for the substrate is not biocompatible, then a biocompatible polymer should be used as a bottom layer. The layers may be adhered to each other using heat to fuse the edges, co-extrusion or co-injection, interlocking mechanical connections, encapsulation and/or with an adhesive, including a biocompatible sealant such as LOCTITE® medical device adhesive. Rigid materials having a very low thickness so they are sufficiently flexible, such as silicon, may also be included. The composition of each of the substrate, top layer and bottom layer may be chosen independently.

Preferably, each of the substrate, top layer and optional bottom layer, independently has a thickness of 5 to 500 μm, more preferably 25 to 200 μm, including 30, 40, 50, 60, 70, 80, 90, 95, 100, 110, 120, 130, 140, 150, 160, 170, 180 and 190 μm. Preferably, the layers have a length and width sufficient to contain all the desired components of the component layer, and has a size sufficient for an adult to grasp and place on the skin by hand. Preferably the substrate, top layer and optional bottom layer have a width of 0.25 to 15 cm, more preferably 0.5 to 10 cm, including 0.75, 1, 1.25, 1.5, 1.75, 2, 2.25, 2.5, 2.75, 3, 3.5, 4, 4.5, 5, 6, 7, 8 and 9 cm. Preferably the substrate, top layer and optional bottom layer have a length of 0.25 to 15 cm, more preferably 0.5 to 10 cm, including 0.75, 1, 1.25, 1.5, 1.75, 2, 2.25, 2.5, 2.75, 3, 3.5, 4, 4.5, 5, 6, 7, 8 and 9 cm. The device may have any shape, including rectangular, circular, oval, 2-lobed, 3-lobed, 4-lobed, an irregularly shaped. The weight of the flexible conductive hearing aid will depend on the thickness, size and composition of the various parts and components. Preferably, the flexible conductive hearing aid has a weight of at most 3 g, preferably at most 1.0 g, more preferably at most 500 mg, even more preferably at most 250 mg, including at most 200, 150, 120, 100, 50, 20 or 10 mg, and all ranges therebetween.

Optionally, a biocompatible adhesive may be used on the underside of the substrate or the optional bottom layer, for adhering the flexible conductive hearing aid to skin. Such an adhesive may not be necessary if the weight of the device is low enough and a polymer is used for the substrate or the optional bottom layer, that naturally sticks to skin without an adhesive, such as by fluid capillary forces, van der Waals forces, or other adhesion mechanisms. For example, when PDMS is used and the flexible conductive hearing aid has a weight of at most 120 mg, it may naturally stick to skin. In such a circumstance, an adhesive force of only 1-2 kPa is necessary to keep the device in place on skin during use. Examples of materials used for skin adhesion of a light weight device without an adhesive may be found in [2].

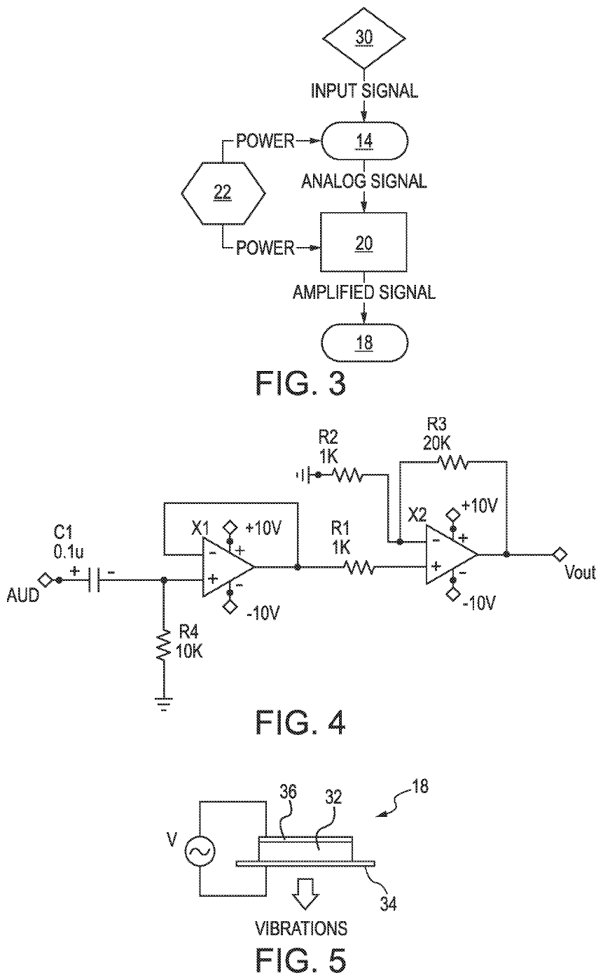

FIG. 3 is a flow chart showing a method carried out by the flexible conductive hearing aid. Once the sound signal, 30, has been received by the microphone, 14, it converts the sound into an analog signal. The analog signal is typically not strong enough for it to activate the actuator. If necessary, the electronic circuits, 20, further amplify the signal though an audio amplifier circuit. Optionally, the electronic circuits can filter out unwanted noise from the input signal and amplify the analog signal, to provide an amplified signal, to provide enough voltage to activate the actuator. Once the amplified signal reaches the actuator, 18, the actuator will receive the signal and produce an analog vibration signal equivalent to sound. The power source, 22, provides power to operate the microphone and the electrical circuits, and any other component requiring power.

The electronic circuits receive the signal from the microphone, and then amplify and transfer the signal to the actuator. The electronic circuits may carry out other functions, such as filter the signal, managing and delivering power to the device components from the power source, carry out analog-to-digital and digital-to-analog conversions, signal processing, and/or allow for wireless remote control or programming of the device. Although illustrated as a single component, the device may include multiple electronic circuits. The electronic circuits may be electrically connected to each, some and/or all of the components on the device. The electronic circuits may be implemented, for example, as a system-on-a-chip as described in [2]. Alternatively, silicon nanostructures and electrical interconnects may be embedded onto flexible substrates through use of an ultrathin silicon layer with 100-nm thickness and transferred onto the flexible substrate, for example as described in [49]. Interconnects and other structures may be patterned onto the flexible substrate, as described in [51]. These structures allow the flexible conductive hearing aid to benefit from semiconductor materials, microelectronic devices and micro-actuators. These structures may be implemented on flexible substrates for electrical interconnections, antennas, acoustic matching, and wireless chargers. In addition, copper traces and electrical interconnects can be patterned on two different polymer substrates, including PDMS and polyimide [51].

The electronic circuits may also have a charger circuit. The charging circuit is preferably present when the device may be charged wirelessly, and includes a receiving coil, a tank circuit, an AC/DC bridge rectifier, a filter, and optionally batteries. The charging circuit may be wirelessly coupled to a transmitter module including a transmitter coil for wireless powering a hearing aid, or for wirelessly recharging batteries on a hearing aid. A charging circuit is illustrated in FIG. 27.

FIG. 4 is a circuit diagram showing an example of electronic circuits which may be used to convert a sound signal into an amplified and filtered signal to drive an actuator. The circuits include two amplifiers, a buffer, and an audio amplifier. The first amplifier is a buffer which provides sufficient drive capability so the signal being passed to the succeeding part of the circuit has sufficient current for the low impedance input allowing it to retain the same voltage level. The second amplifier is an audio amplifier which serves as a solution to amplify the signal further as it is typically not strong enough to drive the actuator if the device were to only rely on the buffer itself. In a variation, the audio amplifier also serves as a high pass filter allowing the signal to be filtered from the low noise that occurs in the input signal. The audio amplifier has a gain of 10 to 5000, more preferably 20 to 500, including 50, 100, 300 and all ranges therebetween. The gain should be adequate to increase the output voltage so that there is sufficient voltage to drive the actuator.

A microphone receives sound from the air and converts the sound into an analog electrical signal. The microphone is powered by electricity from the power source, and will be electrically connected to the power source. Preferably, the microphone is micro-electromechanical systems (MEMS) microphone having a membrane diameter of, for example, 3 mm and a thickness of 2 μm. The microphone may be piezoelectric, condenser, or have a conductive membrane. Examples of suitable microphones are described in [41] and [42]. In another example, a polymer-based micro-membrane with wide bandwidth for a microphone may be used [50].

An actuator convers an electrical signal into vibrations. When integrated onto the flexible substrate, the vibrations can pass through the skin and bone to reach the cochlea and be perceived as sound. Preferably, as shown in FIG. 5, the actuator is a piezoelectric actuator, 18, which includes a top electrode, 36, a piezoelectric material, 32, such as lead zirconate titanate, and a bottom electrode, 34, made of a rigid conductive material, such as aluminum, brass, doped silicon or a gold coated rigid plastic substrate. The bottom electrode may be, preferably, a disk 6 mm in diameter with a thickness of 5 μm. Examples of suitable actuators may be found in, for example, [4], [47] and [48]. Nano-cone structures may also be included on the bottom electrode for vibrational matching between layers with wide bandwidth, as described in [49] and [52]. Table 1, below, shows reflection (R) and transmission (T) of vibrations from the interface of various mediums. Although 50% of the vibrations are reflected as it passes from skin to bone, less than 1% is reflected when sound passes from PDMS to skin. Preferably, when the flexible conductive hearing aid is in contact with human skin, at least 50% of the vibrations are transmitted to human skin, more preferably at least 75%, more preferably at least 80%, at least 85%, at least 90%, at least 95%, or at least 99%.

TABLE 1
Reflection (R) and transmission (T) of sounds
from the interface of various mediums.

| z1 (MRayls) | z2 (MRayls) | R (%) | T (%) |
|---|---|---|---|
| Skin 1.34 | Bone 7.8 | 50 | 50 |
| Silicon 19.7 | Skin 1.34 | 76.1 | 23.9 |
| Quartz 13.44 | Skin 1.34 | 67 | 33 |
| SU8 3.4 | Skin 1.34 | 18.9 | 81.1 |
| Parylene-C 2.76 | Skin 1.34 | 12 | 88 |
| PDMS 1.44 | Skin 1.34 | 0.1 | 99.9 |

Lightweight micro-epidermal actuators (MEAs) may be designed with an engineered frequency band to cut off unwanted low-frequency vibrations associated with body and facial motions. For example, MEAs may be designed to produce vibrations up to 20 kHz and not to respond to low frequency vibrations below 20 Hz. Preferably, the actuator has an output force level of at least 60 dB, more preferably at least 80 dB, more preferably at least 90 dB, including 60-120 dB, for example 65, 70, 75, 80, 85, 90, 95, 100, 105, 110 and 115 dB. This loudness is comparable to the power of the COCHLEAR™ BAHA® 5 (90-120 dB). Such an actuator is powerful enough to compensate for the loss at the skin-bone interface and bypass CHL.

The strength of the vibrations may be increased by using multiple actuators, such as 2, 3, 4 or more actuators. When multiple actuators are used, they may each be the same, or each actuator may be adapted to provide vibrations at different frequencies, to improve the overall vibration performance across a range of frequencies.

A power source is used to provide power to the various parts of the device, including the electrical circuits and the microphone. The powers source may be electrically connected to additional components, such as the optional antenna. The power source may be, for example, a battery, a capacitor, a thermoelectric device, or a receiver for wireless electric power, or combinations thereof. When the device is adapted to allow for wireless charging, such as by including an antenna, a wireless transmitter may be included with the device as a kit, to provide an alternative magnetic field for charging the batters, or even for running the hearing aid so that batteries are not required. Examples of flexible batteries and receiver for wireless electrical power or charging of batteries may be found in [2], [43], [44] and [45].

The optional antenna may be used to receive wireless electrical power to recharge a battery, or charge up a capacitor, on the device. The optional antenna may also be connected to the electrical circuit for receiving blue tooth, WiFi, or other signals for programing or controlling the device. The antenna is preferably made of any conductive material, such as copper, aluminum, silver and/or gold. Multiple antennas may be used. For example, one antenna may be used to receive signals for programming and control, with a separate second antenna used as a receiver for wireless recharging. Various techniques for forming such conductive structures may be used, such as sputter and evaporation.

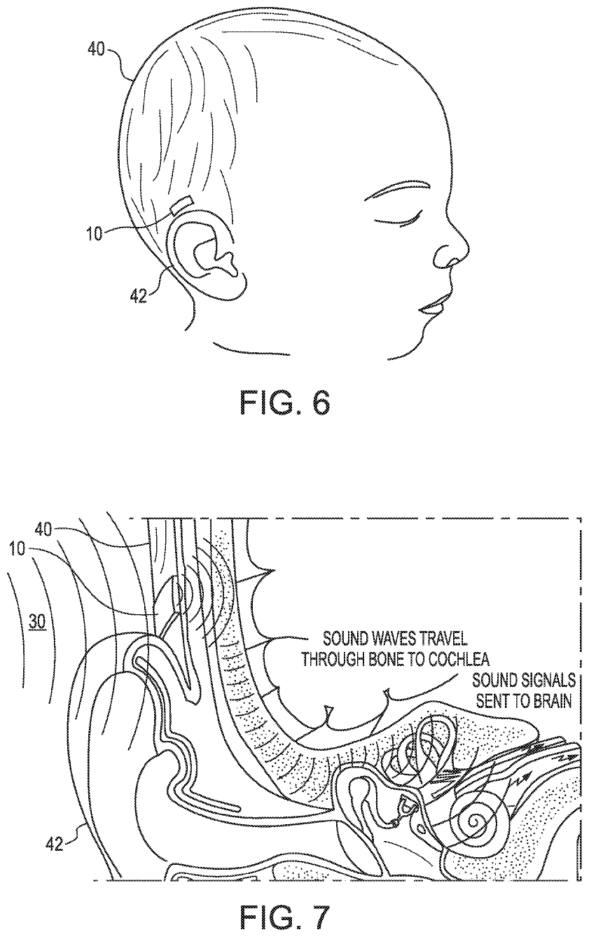

FIG. 6 and FIG. 7 illustrate an example of the flexible conductive hearing aid, 10, in use. As shown in FIG. 6, the hearing aid sticks to the skin on the head, 40, behind the ear, 42, of an infant. FIG. 7 illustrates sounds, 30, in the environment being picked up by the microphone in the hearing aid, 10, and amplified by electronics in the device. An actuator in the device generates vibrations on the epidermis to transfer sounds to the cochlea via the skin through the temporal bone.

### Examples

### Example 1: Micro/Nanostructures onto Flexible Substrates

A device was produced includes the following components: Micro-electromechanical systems (MEMS) microphone, TL072 integrated circuit (IC), micro-actuators, piezoelectric actuator, other necessary electronic components (resistors, capacitors, transistors, etc.), and electronics lab equipment (oscilloscope, signal generator, voltage source, digital multimeter (DMM)). The flowchart in FIG. 3 provides a general description for the device's functionality.

The circuit shown in FIG. 4 was tested. From the circuit it was observed that the device does in fact react to sound from the environment as when speaking into the microphone the vibrations produced by the actuator correspond to the words being spoken. During testing some of the signals that were outputted from the circuit were analyzed by an oscilloscope. The signals show that there is enough voltage to activate the actuator and that there is very little time delay and phase shift. The device is also powered by an external voltage source which powers the MEMS microphone with 5V and the amplifier circuit with +/−10 V. Higher voltages are also possible.

### Example 2: Experimental Results for Validation of Micro-Epidermal Actuator

Bulky actuators based on electromagnetic actuation are a major obstacle to miniaturize the size of conductive hearing aids. These actuators are power hungry and inherently large. To achieve band-aid-like, pediatric-friendly conductive hearing aids, thin-film, micro-epidermal actuators were developed to be attached on skin and generate vibrations. Micro-epidermal actuators include a piezoelectric layer, a brass plate and a flexible substrate. When an alternating electric field is applied to the piezoelectric layer, the brass plate bends, thus generating vibrations on the flexible substrate (such as PDMS). A piezoelectric and brass plate were embedded on to a PDMS layer to achieve micro-epidermal actuators. PDMS is a conformal, biocompatible, elastomer polymer. Mechanical properties of PDMS mostly match those of human skin. This improves energy transmission of vibrations from PDMS to skin.

A high-precision laser Doppler vibrometer (LDV) was used to study the vibrations on micro-epidermal actuators and surface of skin and bone. LDV measures the velocity and calculates displacement and accelerations. Initially an actuator with diameter of 20 mm (brass plate) was taped with a lead zirconate titanite disk having a 15 mm diameter. The PDMS thickness was from 50 to 1000 μm. For thick PDMS, the piezoelectric was covered by PDMS. On thinner devices, the piezoelectric layer was implemented on one side of the PDMS.

A cadaveric skull calvarium (from skullsunlimited.com) was used to study the vibrations. A peak was observed at 3 kHz corresponding to a resonance. Displacement was reduced from 200 nm to 6.5 nm at 5 kHz (by a factor of 30). This reduction is attributed to damping of skull, thick PDMS as well as the mechanical properties of rigid bone. Displacement is lower in rigid bone; however, the force level is higher. The transmission of vibrations was measured at various distances from the center of the actuator at 4 kHz. Displacement is exponentially reduced by increasing distance. The vibrations were reduced from 78 nm displacement to 2.8 nm at a distance of 65 mm. The distance from ear to cochlea in infants is less than this range (roughly 10 mm), in which the damping is insignificant.

### Example 3: A Microepidermal Actuator on a Flexible Substrate

Simulations of a microepidermal actuator on a flexible substrate were carried out with ANSYS software to determine the dimensions of piezoelectric actuators for maximal vibration conduction. Laser Doppler vibrometer was also used to measure displacement of vibrations for an actuator placed on a segment of cadaveric skull calvarium. We analyzed a microepidermal actuator with a lead zirconate titanite (PZT-5A) on a brass plate. In the simulation PZT was covered by a polydimethylsiloxane (PDMS) layer as elastomer substrate. The stress and displacement of vibrations on PZT layer, PDMS, skin and bone, were analyzed.

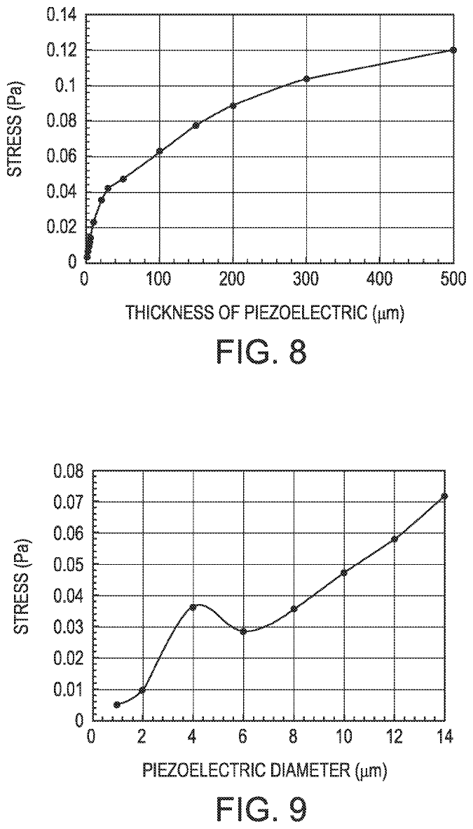

The results show that increasing the diameter of a circular PZT disk from 1 to 14 mm (FIG. 8) and thickness of PZT layer from 5 to 500 μm (FIG. 9) will significantly increase the resultant stress in the bone. Vibrations are transferred from PZT to PDMS, skin and finally to bone. The aim of the analysis is to determine the dimensions for maximal stress in bone. Simulation shows that displacement of vibrations is much lower in the bone than PZT and PDMS. A local peak at 4 mm diameter in stress was observed (FIG. 9), corresponding to resonance frequency of the actuators. Time variant analysis was used to study the transmission of vibrations.

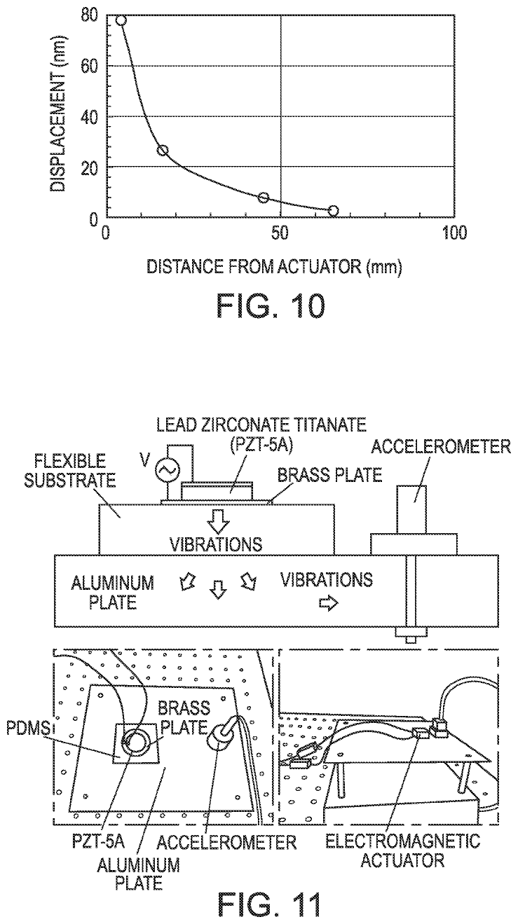

High-precision laser doppler vibrometer (LDV) from Vibrations Inc. was used to measure the vibrations on actuators. The vibrations on a volunteer and a piece of bone from a human skull were also measured. The data show the displacement is reduced on a skull by a factor of 50% at the distance of 1 cm from actuator (FIG. 10). The distance between the device and cochlea is lower than 2 cm in newborns and infants and therefore vibrations will be received by the cochlea.

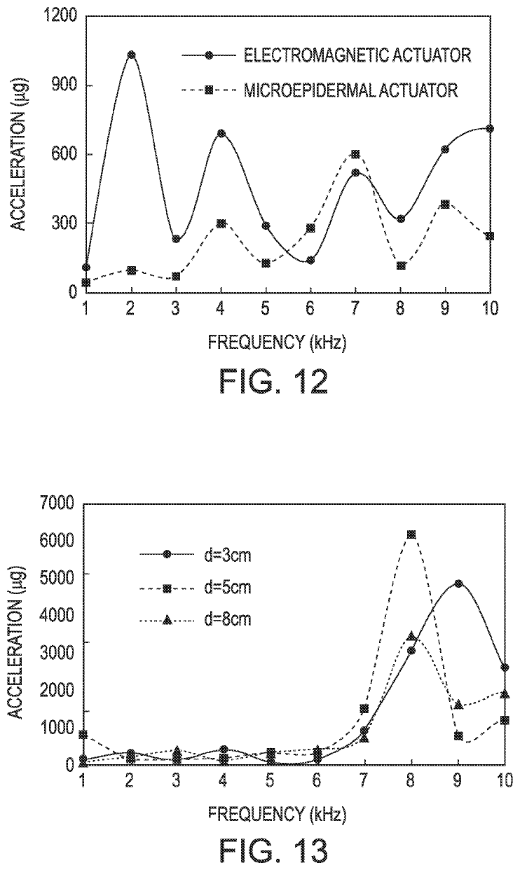

A piezoelectric actuator on a flexible substrate was prepared to achieve a micro-epidermal actuator for a noninvasive, flexible adhesive bandages-like conductive hearing aid. A circular lead zirconate titanite (PZT) actuators was prepared on a polydimethylsiloxane (PDMS) substrate (FIG. 11) to be placed on epidermis layer behind the ear and generate vibrations to bypass conductive hearing loss. The overall thickness of the actuator was 350 μm and the soft PDMS would be in direct contact with infants' skin to provide a high level of comfort and reduce the risk of skin reaction. The vibration strength of lead zirconate titanate (PZT-A) on PDMS was measured across 10 kHz bandwidth and the results were compared against an electromagnetic, bone conduction actuator (FIG. 12).

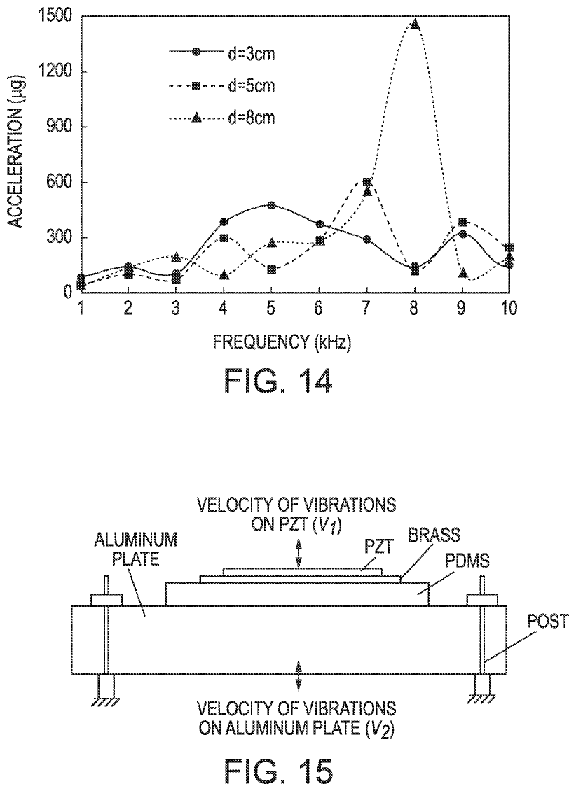

Two-part liquid components (Sylgard 184 silicone elastomer kit) with weight ratio 10:1 was mixed, and then the liquid mixture was spun on a 3-inch diameter wafer at speed 900 RPM. A 100 μm-thick PZT-5A was fixed on PDMS layer after spin coating, and then the wafer was cured at room temperature (27° C.) for 48 hours. The thickness of PDMS was measured to be 100 μm. The PDMS with actuator was peeled off from the surface of the wafer. For vibration measurement, a 1-mm thick aluminum plate was fixed on four corners, and a high-precision accelerometer (352B from PCB Piezotronics) was vertically bolted on the aluminum plate (FIG. 11). The accelerometer has a resonance frequency of >25 kHz, bandwidth 10 kHz and spectral noise 15 μg/√Hz. FIG. 9 compares acceleration from 15 mm-diameter micro-epidermal on 100 μm thick PDMS with vibrations from electromagnetic actuator for a frequency band 10 kHz. The microepidermal actuator generated 597 μg acceleration at 7 kHz, which is slightly higher than the electromagnetic actuator (520 μg). At most other frequencies, the strength of acceleration is 1.5 to 3-fold higher for the electromagnetic actuator (except 2 kHz). However, the power consumption of the electromagnetic actuator (1 W) is 3 orders of magnitude higher than that of the microepidermal actuator (1 mW) [7]. The distance between the accelerometer and center of actuators was modified from 3 cm to 8 cm, shifting the resonance frequency (FIG. 13 and FIG. 14). Vibrational mode at 8 kHz on PZT, PDMS and aluminum plate were simulated using ANSYS. The maximum acceleration on PZT and PDMS occurs at the center of actuator, while the maximum acceleration mostly distributed around the edges of aluminum plate.

### Example 4: Vibration Transmissibility of Unimorph Piezoelectric Actuator on Flexible Substrate

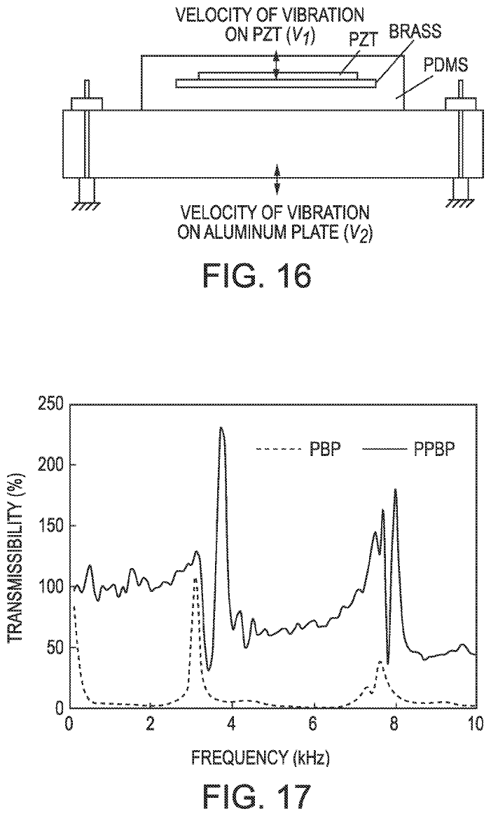

In this example two designs of piezoelectric (PZT) actuators on flexible substrates were developed and measured transmissibility of vibrations using a laser Doppler vibrometer (LDV). Two actuators layered were developed as follows: PZT-Brass-PDMS (PBP) (FIG. 15) and PDMS-PZT-Brass-PDMS (PPBP) (FIG. 16). The PZT-5H (50 μm thickness) and brass plate (100 μm thickness) were attached with a thin layer of adhesive to the surface of the 1-mm thick PDMS for PBP design. A PZT and brass plate were embedded into a PDMS mold for the PPBP actuator.

FIG. 15 and FIG. 16 show the experimental setup to measure the vibrations from the actuators of unimorph circular piezoelectric actuators on flexible substrates placed on a 1-mm thick aluminum plates as foundations. LDV was used to measure vibrations on PZT, PDMS and foundation. In FIG. 15, PZT/brass is attached to the surface of PDMS (PBP). In FIG. 16, the PZT actuator with brass plate was embedded into PDMS (PPBP). A 15-mm diameter PZT with 20-mm diameter brass and a square-shaped PDMS was placed on a rigid 1 mm-thick aluminum plate. The plate was fixed with posts to an optical table. The vibrations that were transmitted from the actuator to the other side of the rigid aluminum foundation were measured. In FIG. 15, the PZT/brass was attached on top of the PDMS using super glue (PBP design). In FIG. 16, the PZT/brass was embedded in the flexible substrate, the PDMS covers the whole structure to form PPBP device. A continuous 10 V peak-peak signal with 5 V offset was applied across the actuators. The frequency was changed from 100 Hz to 10 kHz in increments of 100 Hz. The velocity of the vibrations was measured from the surface of the PZT and the back of the rigid aluminum using Laser Point LP01-HF from Optical Measurement Systems. Contactless measurements of velocity and displacement from the PZT, PDMS and aluminum were obtained. The laser is beamed on the center of the actuator and on the corresponding point on the back side of the aluminum plate (foundation).

Velocity vs. frequency on the PZT (V₁) and on the backside of aluminum plate (V₂) for two designs were recorded. The velocity on the rigid plate was divided by the velocity on the PZT layer at each frequency to obtain transmissibility (T) of the vibrations (T=V₂/V₁). FIG. 17 shows the transmissibility of the designs over 10 kHz bandwidth. A small portion (2 mm×2 mm) of PDMS on the center of PZT for PPBP device was removed to accurately measure vibrations on embedded PZT layer. The PBP design shows two resonance frequencies at 3.1 kHz with 107% transmissibility and 7.6 kHz with 38% transmissibility. The embedded design shows multiple resonance frequencies with nonlinear characteristics. The maximum resonance frequencies occurred at 3.7 kHz with 230% transmissibility. The transmissibility from PZT to the rigid substrate is much more effective for the embedded design (PPBP). This may be due to efficient coupling of vibrations and lower damping for the PPBP device. In the PPBP design, the range of motions on PZT is limited (40 nm) by PDMS on the sides, and most of the vibrations are transmitted to the foundation. In the PBP design, the PZT actuator has no PDMS barrier for upward motions, resulting in a large displacement (800 nm at the center at resonance frequency) of the actuator. Therefore, fewer vibrations are coupled into PDMS and the underlying foundation.

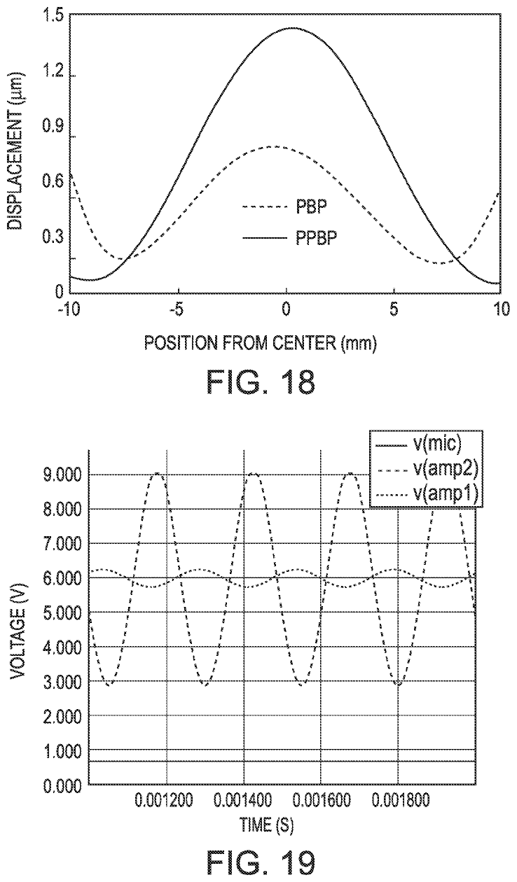

Also measured was the displacement of vibrations on the PZT actuator for PBP design and the displacement of PDMS on the surface of PPBP design at 5 kHz as shown in FIG. 18. The surface of the devices was scanned across the diameter of the actuator. The location of the laser beam was manually adjusted with increments of roughly 1 mm (22 point across 20 mm). For a PZT actuator on the PDMS, the maximum displacement was 750 nm, which occurred in the center. For the PPBP design the maximum displacement on top of PDMS layer was 1,480 nm. The maximum displacements on PZT embedded in PDMS (PPBP design) was only 40 nm at 7.7 kHz. This shows the displacement on the embedded PZT was significantly lower than displacement on PZT attached to the surface of PDMS.

It was concluded that the embedded actuator (PPBP design) showed higher transmissibility for velocity. This is attributed to the efficient coupling, lower damping, and security of the PZT actuator within the PDMS. The results show that the PPBP design has a higher transmissibility for velocity due to efficient coupling, lower damping, and security of the PZT actuator within the PDMS. This design will be used in a flexible conductive hearing aids to efficiently transmit vibrations from the actuator to bone and overcome CHL.

### Example 5: Flexible Conductive Hearing Aids

A noninvasive, flexible aid to address pediatric conductive hearing loss was prepared. The flexible hearing aid is capable of converting external sounds to vibrations, relying on a microelectromechanical microphone, electronic circuits for amplification and batteries to power the device. These components were printed on a flexible substrate attached to a micro-epidermal actuator for generating vibrations on infants' skin.

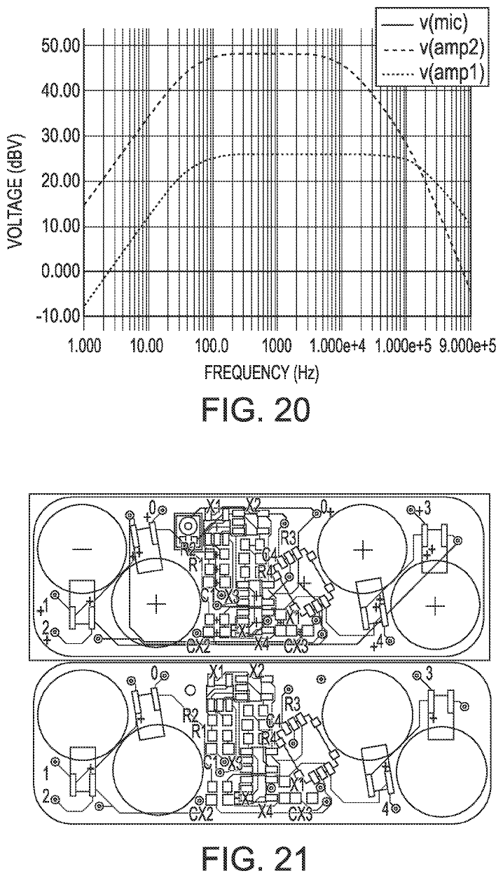

The initial design and simulation of the circuit were conducted through Eagle CAD, a circuit design and simulation software. It is modeled to have two stages of amplification, for a total ideal gain of 260. The gain can be tunable. Experimentally, the piezoelectric actuators intended for this device produced larger vibrations at 10 V. With an average peak-to-peak voltage input of 25 mA, it amplified the signal to 6.5 V. FIG. 19 and FIG. 20 show transient and AC sweep simulation, displaying three stages: microphone input, first amplification, second amplification. This gain will provide enough maneuverability for the signal to either increase or decrease the signal without saturation or attenuation. Each amplification stage is separated by buffers to minimize any loading effects. Built-in to the circuit is a bandpass filter, with the lower and upper cutoff frequency at 48 Hz and 12.2 kHz respectively. While the human voice usually ranges under 1 kHz, most conductive hearing aids operate up to 10 kHz. Four rechargeable 3 V batteries are arranged in series to provide an ideal maximum DC voltage of 12 V for the hearing aid.

The schematics were then redesigned as a 2-layer printed circuit board (PCB) schematic, barely fitting 48.5×17.1 mm² (1.91×0.67 in²). The copper layers and silkscreens are printed onto a polyamide substrate with a thickness of approximately 100 μm. Compared to traditional PCBs, the polyamide substrate is flexible, and allows a high degree of bending. This feature is restricted by the rigidity of components soldered to the board. All components of the circuit along with the board are RoHS (Restriction of Hazardous Substances Directive) compliant. FIG. 21 illustrates the PCB schematic design and the PCB print of the device.

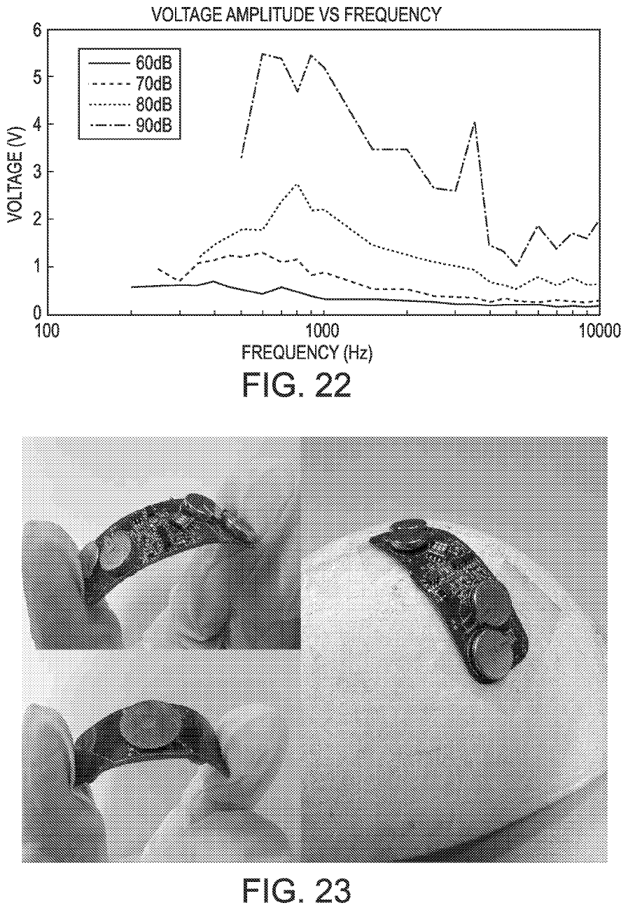

The circuit assembly procedures have been optimized for a heat soldering gun, using lead-free solder paste. The order of soldering goes from high to low heat profiles, with the MEMS (Microelectromechanical System) microphone and the actuator being the final two pieces of the assembly. The circuit was then characterized electrically, with the preliminary frequency-voltage profile shown in FIG. 22, matching that of a typical hearing aid response. Each decibel profile was kept within ±1 dB, verified with a decibel meter.

The device is shown in FIG. 23, having the batteries and circuit on one side, with the actuator on the reverse side, and demonstrating the flexibility of the device and attachment to a skull. The device has been tested on a willing and healthy participant (FIG. 24). To simulate hearing loss, noise-cancellation earmuffs (32 dB HL rated) were used in conjunction with the device. The device was attached with a double-sided tape onto the forehead of the participant. To further increase the strength of vibrations and extend the application of flexible hearing aids to adult patients, multiple thin-film piezoelectric actuators may be used.

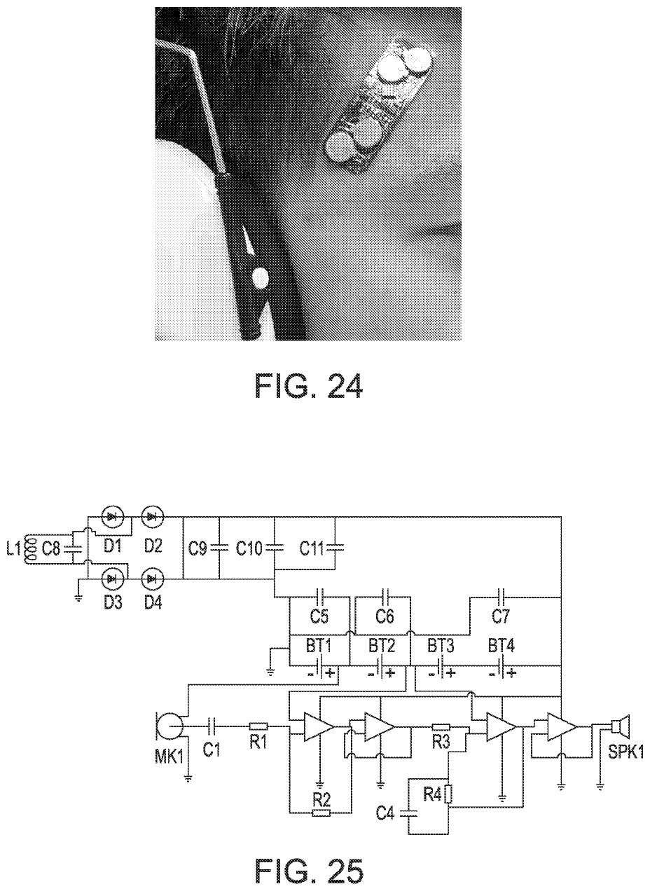

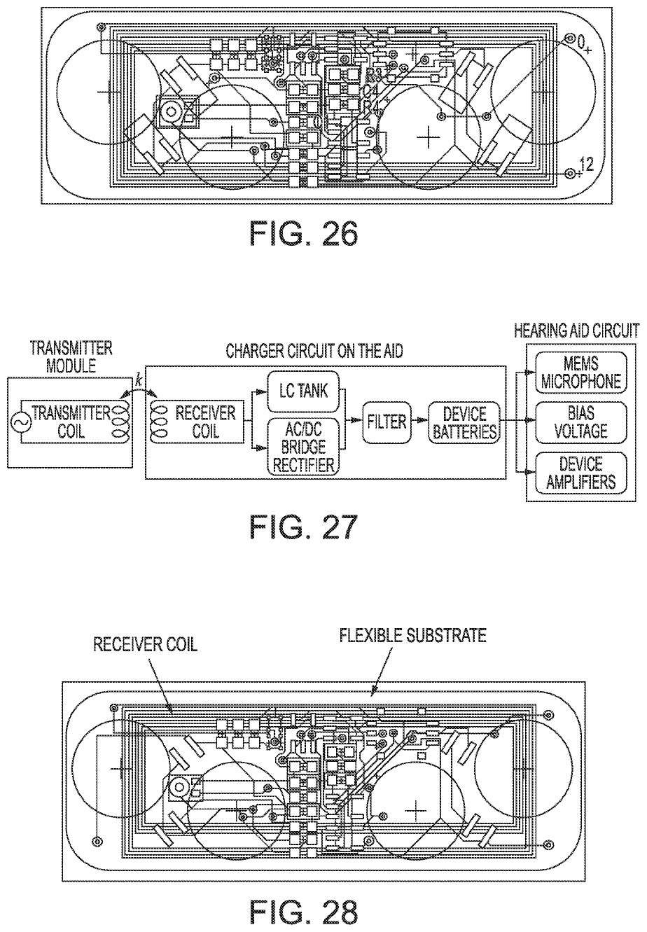

Batteries may also be charged with a wireless coil. The charger was calculated to work at a resonance frequency of 185 kHz, with an AC/DC converter wiring the DC voltage to the batteries. The extended circuit has been tested on a breadboard, and the batteries were successfully charged. The charger would provide a user-friendly method of charging the hearing aid, which is a step up from the previous circuit that required wire probes. The wireless device is designed to be 50 ×17.1 mm². A schematic of the device with a wireless charging coil is shown is shown in FIG. 25, and the PCB design of the hearing aid is shown in FIG. 26.

### Example 6: Wireless Charger for Flexible Pediatric Conductive Hearing Aid

A wireless charger has been designed and integrated into the flexible, pediatric hearing aid. This feature will eliminate the need for a rigid port and wires to charge the batteries. This will reduce the burden of removing the hearing aid from the surface of skin to charge or change batteries. The wireless charger will also provide a source for powering the hearing aid and charging the batteries when the infants and pediatric patients are in bed. In this design, a wireless transmitter is placed under the bed to generate an alternative magnetic field (AMF) for the hearing aid. A coil on the perimeter of the hearing aid was also designed to receive AMF and energy. Two coils are electromagnetically coupled with coefficient of k to transfer energy from transmitter module to the receiver coil. AMF induces voltage in the receiver and provides a source of energy for the hearing aid.

In an experiment, the transmitter was able to produce a peak-to-peak voltage of 119 V, at 185 kHz frequency with a DC bias of 30 V. The wireless charger was tested with an external breadboard receiver circuit. Initially, the magnetic field is received by the coil, paired with a parallel capacitor for resonance at 185 kHz. The voltage was converted from AC to DC with a full bridge consisting of Schottky diodes with output of 12.8 V DC and 11.08 mA current. The output power in the receiver was roughly 140 mW. These values were obtained when the receiver coil was placed directly against the transmitter coil. Ripple effects are removed with several capacitors, decreasing the AC peak-to-peak voltage to under 1 V. Batteries on a hearing aid, that were partially charged, were recharged over the course of 30 minutes. The battery voltage was increased from 7 V (partially charged) to 11.5 V (fully charged). The wireless charger was able to recharge the battery to the nominal maximum DC voltage of the battery (11.5 V). The device could also benefit from NFC (Near Field Communication) wireless charge at frequency 13.56 MHz.

The hearing aid was tested as the batteries were charging with wireless charger; it showed that the current consumption was low (<10 mA) from the charger itself. The charging was working properly, without noticeable signal interference to the hearing aid. There was no observable loss of power over the course of 2 hours of device usage and wireless charging. The maximum peak-to-peak voltage of the signal was consistent throughout the testing period. Using Eagle CAD software, the original hearing aid was redesigned to include the receiver coil and charging circuits. This design slightly increased the size of the device, from 48.5×17.1 mm² (1.91×0.67 in²) to 50×17.1 mm² (1.97×0.67 in²). A device block diagram and integrated circuit with wireless charger are illustrated in FIG. 27 and FIG. 28. In FIG. 27 is shown a block diagram of the charger circuit starting from the receiver coil obtaining an AC voltage from the transmitter coil, processed with the LC tank, AC/DC bridge, and several filters, before sending the voltage to the batteries on the hearing aid. In FIG. 28 is shown the wireless charger integrated on the hearing aid device viewed with Eagle CAD. The coil of the wireless charger was placed on the backside of the flexible circuit board.

### REFERENCES

1. D.-H. Kim et al, “Epidermal Electronics,” Science, vol. 333, no. 6044, pp. 838-843, 2011.
2. H. U. Chung et al., “Binodal, wireless epidermal electronic systems with in-sensor analytics for neonatal intensive care,” Science, vol. 363, no. 6430, pp. 0-13, 2019.
3. Y. Liu et al., “Epidermal mechano-acoustic sensing electronics for cardiovascular diagnostics and humanmachine interfaces,” Sci. Adv., vol. 2, no. 11, p. e1601185, 2016.
4. H. Wang, Z. Chen, and H. Xie, “A high-SPL piezoelectric MEMS loud speaker based on thin ceramic PZT,” Sensors Actuators, A Phys., vol. 309, p. 112018, 2020.
5. S. Kang et al., “Transparent and conductive nanomembranes with orthogonal silver nanowire arrays for skin-attachable loudspeakers and microphones,” Sci. Adv., vol. 4, no. 8, pp. 1-12, 2018.
6. J. Cohen, Statistical Power Analysis for the Behavioral Sciences, Second. LAWRENCE ERLBAUM ASSOCIATES, 1988.
7. T. Jordan, Z. Ounaies, J. Tripp, and P. Tcheng, “Electrical Properties and Power Considerations of a Piezoelectric Actuator,” in MRS Proceedings, 1999, vol. 604, p. 203.
8. M. Koo et al., “Bendable inorganic thin-film battery for fully flexible electronic systems,” Nano Lett., vol. 12, no. 9, pp. 4810-4816, 2012.
9. A. Khan, Z. Abas, H. Soo Kim, and I. K. Oh, “Piezoelectric thin films: An integrated review of transducers and energy harvesting,” Smart Mater. Struct., vol. 25, no. 5, p. 0, 2016.
10. G. Paludetti et al., “Infant hearing loss: from diagnosis to therapy,” Acta Otorhinolaryngol. Ital., vol. 32, no. 6, pp. 347-70, 2012.
11. B. O. Olusanya and V. E. Newton, “Global burden of childhood hearing impairment and disease control priorities for developing countries,” Lancet, vol. 369, no. 9569, pp. 1314-1317, 2007.
12. M. Ptok, “Early Detection of Hearing Impairment in Newborns and Infants,” Dtsch. Arztebl., vol. 108, no. 25, pp. 426-431, 2011.
13. T. Finitzo, K. Albright, and J. O'Neal, “The newborn with hearing loss: Detection in the nursery,” Pediatrics, vol. 102, no. 6, pp. 1452-1460, 1998.
14. T. Zahnert, “The Differential Diagnosis of Hearing Loss,” Dtsch. Aerzteblatt Online, vol. 108, no. 25, pp. 433-44, 2011.
15. R. Kaur, M. Morris, and M. E. Pichichero, “Epidemiology of acute otitis media in the postpneumococcal conjugate vaccine era,” Pediatrics, vol. 140, no. 3, 2017.
16. R. S., H. B., T. H., and E.-O. M., “New developments in bone-conduction hearing implants: A review,” Med. Devices Evid. Res., vol. 8, pp. 79-93, 2015.
17. E. Van Spronsen, F. A. Ebbens, P. G. B. Mirck, C. H. M. Van Wettum, and S. Van Der Baan, “Canalplasty: The technique and the analysis of its results,” Am. J. Otolaryngol. —Head Neck Med. Surg., vol. 34, no. 5, pp. 439-444, 2013.
18. A. Hagr, “BAHA: Bone-Anchored Hearing Aid.,” Int. J. Health Sci. (Qassim)., vol. 1, no. 2, pp. 265-26576, 2007.
19. T. Wang and C. Lee, “Zero-Bending Piezoelectric Micromachined Ultrasonic Transducer (pMUT) With Enhanced Transmitting Performance,” J. Microelectromechanical Syst., vol. 24, no. 6, pp. 2083-2091, 2015.
20. D. J. Morris, D. F. Bahr, and M. J. Anderson, “Displacement amplification in curved piezoelectric diaphragm transducers,” Sensors Actuators, A Phys., vol. 141, no. 2, pp. 262-265, 2008.
21. L. Xu, J. Cao, and D. Huang, “Design and characterization of a PVDF ultrasonic acoustic transducer applied in audio beam loudspeaker,” IEEE Int. Conf. Mechatronics Autom. ICMA 2005, vol. 4, no. July, pp. 1992-1997, 2005.
22. H. Basaeri, D. B. Christensen, and S. Roundy, “A review of acoustic power transfer for bio-medical implants,” Smart Mater. Struct., vol. 25, no. 12, pp. 0-24, 2016.
23. R. Tadmor, “The London-van der Waals interaction energy between objects of various geometries,” J. Phys. Condens. Matter, vol. 13, no. 9, 2001.
24. I. M. Ventry, “Effects of conductive hearing loss: Fact or fiction,” J. Speech Hear. Disord., vol. 45, no. 2, pp. 143-156, 1980.
25. J. B. Nadol, “Hearing loss,” N Engl J Med, vol. 329, no. 15, pp. 1092-1102, 1993.
26. I. Rapin, “Conductive hearing loss: effects on children's language and scholastic skills; A review of the literature,” Ann. Otol. Rhinol. Laryngol., vol. 88, pp. 3-12, 1979.
27. K. M. Harmes, R. A. Blackwood, H. L. Burrows, J. M. Cooke, R. Van Harrison, and P. P. Passamani, “Otitis media: Diagnosis and treatment,” Am. Fam. Physician, vol. 88, no. 7, pp. 435-440, 2013.
28. S. Bartel-Friedrich and C. Wulke, “Classification and diagnosis of ear malformations.,” GMS Curr. Top. Otorhinolaryngol. Head Neck Surg., vol. 6, p. Doc05, 2007.
29. P. E. Kelley and M. A. Scholes, “Microtia and Congenital Aural Atresia,” Otolaryngol. Clin. North Am., vol. 40, no. 1, pp. 61-80, 2007.
30. J. F. W. Lo, W. S. S. Tsang, J. Y. K. Yu, O. Y. M. Ho, P. K. M. Ku, and M. C. F. Tong, “Contemporary Hearing Rehabilitation Options in Patients with Aural Atresia,” Biomed Res. Int., vol. 2014, pp. 1-8, 2014.
31. R. Salomone et al., “Pediatric otosclerosis: Case report and literature review,” Braz. J. Otorhinolaryngol., vol. 74, no. 2, pp. 303-306, 2008.
32. D. C. Shonka, W. J. Livingston, and B. W. Kesser, “The Jahrsdoerfer grading scale in surgery to repair congenital aural atresia,” Arch. Otolaryngol. —Head Neck Surg., vol. 134, no. 8, pp. 873-877, 2008.
33. F. Alzhrani, M. M. Mokhatrish, M. O. Al-Momani, H. Alshehri, A. Hagr, and S. N. Garadat, “Effectiveness of stapedotomy in improving hearing sensitivity for 53 otosclerotic patients: Retrospective review,” Ann. Saudi Med., vol. 37, no. 1, pp. 49-55, 2017.
34. S. Reinfeldt, B. Hikansson, H. Taghavi, and M. Eeg-Olofsson, “New developments in bone-conduction hearing implants: A review,” Med. Devices Evid. Res., vol. 8, pp. 79-93, 2015.
35. B. Hakansson et aL., “A novel bone conduction implant (BCI): Engineering aspects and pre-clinical studies,” Int. J. Audiol., vol. 49, no. 3, pp. 203-215, 2010.
36. T. Davids, K. A. Gordon, D. Clutton, and B. C. Papsin, “Bone-anchored hearing aids in infants and children younger than 5 years,” Arch. Otolaryngol. —Head Neck Surg., vol. 133, no. 1, pp. 51-55, 2007.
37. C. M. Bunney, P. E., Zink, A. N., Holm, A. A., Billington, C. J., & Kotz, “Neurocognitive Risk in Children with Cochlear Implants,” JAMA Otolaryngol Head Neck Surg., vol. 140, no. 7, pp. 608-615, 2017.
38. T. Kraai, C. Brown, M. Neeff, and K. Fisher, “Complications of bone-anchored hearing aids in pediatric patients,” Int. J. Pediatr. Otorhinolaryngol., vol. 75, no. 6, pp. 749-753, 2011.
39. R. K. Gurgel and C. Shelton, “The SoundBite hearing system: Patient-assessed safety and benefit study,” Laryngoscope, vol. 123, no. 11, pp. 2807-2812, 2013.
40. N. Verstraeten, A. J. Zarowski, T. Somers, D. Riff, and E. F. Offeciers, “Comparison of the audiologic results obtained with the bone-anchored hearing aid attached to the headband, the testband, and to the ‘snap’ abutment,” Otol. Neurotol., vol. 30, no. 1, pp. 70-75, 2009.
41. M. A. Shah, I. A. Shah, D.-G. Lee, and S. Hur, “Design Approaches of MEMS Microphones for Enhanced Performance,” J. Sensors, vol. 2019, pp. 1-26, 2019.
42. J. W. Weigold, T. J. Brosnihan, J. Bergeron, and X. Zhang, “A MEMS Condenser Microphone for Consumer Applications,” in 19th IEEE International Conference on Micro Electro Mechanical Systems, 2006, no. January, pp. 86-89.
43. G. Qian, X. Liao, Y. Zhu, F. Pan, X. Chen, and Y. Yang, “Designing Flexible Lithium-Ion Batteries by Structural Engineering,” ACS Energy Lett., vol. 4, no. 3, pp. 690-701, 2019.
44. T. Tao, S. Lu, and Y. Chen, “A Review of Advanced Flexible Lithium-Ion Batteries,” Adv. Mater. Technol., vol. 3, no. 9, pp. 1-21, 2018.
45. H. Nishide and K. Oyaizu, “Toward flexible batteries.,” Science, vol. 319, no. 5864, pp. 737-738, Feb. 2008.
46. D. H. Shin, K. W. Seong, E. S. Jung, J. H. Cho, and K. Y. Lee, “Design of a dual-coil type electromagnetic actuator for implantable bone conduction hearing devices,” Technol. Heal. Care, vol. 27, no. S1, pp. S445—S454, 2019.
47. R. B. Adamson, M. Bance, and J. A. Brown, “A piezoelectric bone-conduction bending hearing actuator.,” J. Acoust. Soc. Am., vol. 128, no. 4, pp. 2003-2008, 2010.
48. M. Toda and M. L. Thompson, “Contact-type vibration Sensors using curved clamped PVDF film,” IEEE Sens. J., vol. 6, no. 5, pp. 1170-1177, 2006.
49. M. J. Moghimi, J. Fernandes, A. Kanhere, and H. Jiang, “Micro-Fresnel-Zone-Plate Array on Flexible Substrate for Large Field-of-View and Focus Scanning.,” Sci. Rep., vol. 5, p. 15861, 2015.
50. M. J. Moghimi, K. N. Chattergoon, C. R. Wilson, and D. L. Dickensheets, “High Speed Focus Control MEMS Mirror With Controlled Air Damping for Vital Microscopy,” J. Microelectromechanical Syst., vol. 22, no. 4, pp. 938-948, Aug. 2013.
51. M. J. Moghimi, G. Lin, and H. Jiang, “Broadband and Ultrathin Infrared Stealth Sheets,” Adv. Eng. Mater., vol. 1800038, pp. 1-6, 2018.
52. Z. Li et al., “Broadband gradient impedance matching using an acoustic metamaterial for ultrasonic transducers,” Sci. Rep., vol. 7, no. January, pp. 1-9, 2017.
53. T. E. G. Alvarez-Arenas, “Acoustic impedance matching of piezoelectric transducers to the air,” IEEE Trans. Ultrason. Ferroelectr. Freq. Control, vol. 51, no. 5, pp. 624-633, 2004.
54. M. Habal, N. Frans, R. Zelski, and J. Scheuerle, “Percutaneous Bone-Anchored Hearing Aid,” pp. 637-642.
55. A. C. Karwoski, “Testing and Analysis of the Peeling of Medical Adhesives From Human Skin,” pp. 1-368, 2003.
56. A. C. Karwoski and R. H. Plaut, “Experiments on peeling adhesive tapes from human forearms,” Ski. Res. Technol., vol. 10, no. 4, pp. 271-277, 2004.
57. W. Li et al., “Nanogenerator-based dual-functional and self-powered thin patch loudspeaker or microphone for flexible electronics,” Nat. Commun., vol. 8, no. May, pp. 1-9, 2017.
58. D. J. Bell, T. J. Lu, N. A. Fleck, and S. M. Spearing, “MEMS actuators and sensors: Observations on their performance and selection for purpose,” J. Micromechanics Microengineering, vol. 15, no. 7, 2005.
59. J. M. Lin and C. H. Lin, “A novel flexible planar loudspeaker with coils on polyimide diaphragm,” J. Vibroengineering, vol. 20, no. 1, pp. 774-781, 2018.
60. Y. Liu, M. Pharr, and G. A. Salvatore, “Lab-on-Skin: A Review of Flexible and Stretchable Electronics for Wearable Health Monitoring,” ACS Nano, vol. 11, no. 10, pp. 9614-9635, 2017.
61. Marino, L., Cicirello, A. & Hills, D. A. “Displacement transmissibility of a Coulomb friction oscillator subject to joined base-wall motion,” Nonlinear Dyn 98, 2595-2612 (2019). https://doi.org/10.1007/s11071-019-04983-x.

1. A flexible conductive hearing aid, comprising:
(i) a flexible substrate,
(ii) components, on or in the flexible substrate, including
(a) a microphone, configured to produce an electrical signal from sound,
(b) electronic circuits, connected to the microphone, configured to amplifying the electrical signal,
(c) an actuator, connected to the electronic circuits, configures to produce vibrations in the flexible substrate from the amplified electrical signal, and
(d) a power source, connected to the microphone and the electrical circuits,
(iii) optionally, a flexible top layer, on the components, and
(iv) optionally, a flexible bottom layer, wherein the flexible substrate is on the flexible bottom layer.

2. The flexible conductive hearing aid of claim 1, configured to be attached to skin on a patient's skull solely by contact of the flexible substrate or flexible bottom layer, with the skin.

3. The flexible conductive hearing aid of claim 1, wherein (b) the electrical circuits comprise at least 2 amplifiers.

4. The flexible conductive hearing aid of claim 1, wherein the components further comprise an antenna, connected to the power source; and the power source is a battery.

5. The flexible conductive hearing aid of claim 1, wherein (c) the actuator comprises a piezoelectric material.

6. A method of treating conductive hearing loss with a flexible conductive hearing aid having a flexible substrate and optional a flexible bottom layer, the method comprising:
attaching the flexible conductive hearing aid to skin on a patient's skull,
producing an electrical signal from ambient sound,
amplifying the electrical signal, to produce an amplified electrical signal, and
producing vibrations in the flexible conductive hearing aid from the amplified electrical signal.

7. The method of claim 6, wherein the flexible conductive hearing aid is attached to skin on the patient's skull solely by contact of the flexible substrate or flexible bottom layer, with the skin.

8. The method of claim 6, wherein the patient is a pediatric patient or an adult having hearing loss.

9. The method of claim 6, wherein the patient is at most 5 years old.

10. The flexible conductive hearing aid of claim 1, wherein the flexible conductive hearing aid is configured to be powered wirelessly or recharge wirelessly.

11. The flexible conductive hearing aid of claim 1, wherein the flexible conductive hearing aid has a width of at most 5 cm, length of at most 5 cm, and a thickness of at most 1 mm.

12. The flexible conductive hearing aid of claim 1, wherein the flexible conductive hearing aid has a width of at most 3 cm, length of at most 2 cm, and a thickness of at most 500 μm.

13. The flexible conductive hearing aid of claim 1, wherein the flexible conductive hearing aid produces an output force level at the actuator of at least 60 dB.

14. The flexible conductive hearing aid of claim 1, wherein when the flexible conductive hearing aid is in contact with human skin, at least 50% of the vibrations are transmitted to the human skin.

15. The flexible conductive hearing aid of claim 1, wherein when the flexible conductive hearing aid is in contact with human skin, at least 90% of the vibrations are transmitted to the human skin.

16. The flexible conductive hearing aid of claim 1, wherein the flexible conductive hearing aid has a weight of at most 3 grams.

17. The flexible conductive hearing aid of claim 1, wherein the flexible conductive hearing aid is configured to filter noise from the electrical signal or amplified electrical signal.

18. The method of claim 6, wherein the flexible conductive hearing aid is attached to the skin without an adhesive.

19. The flexible conductive hearing aid of claim 1, wherein the flexible conductive hearing aid comprises multiple actuators.

20. (canceled)

21. (canceled)
